(19) United States
(12) Patent Application Publication
(10) Pub. No.: US 2013/0032176 A1
(43) Pub. Date: Feb. 7, 2013

(54) METHOD FOR CLEANING AN OUTER SURFACE AND USE OF A MULTI-JET ROTATING HEAD IN THE CLEANING METHOD

(71) Applicants: Philippe Jouaud, Cestas (FR); Paul Wakim, La Motte Tilly (FR)

(72) Inventors: Philippe Jouaud, Cestas (FR); Paul Wakim, La Motte Tilly (FR)

(73) Assignees: MALTERIES SOUFFLET, Nogent Sur Marne (FR); ALFA LAVAL CORPORATE AB, Lund (SE)

(21) Appl. No.: 13/642,278

(22) PCT Filed: Apr. 12, 2011
(86) PCT No.: PCT/EP2011/055721

§ 371 Date: Oct. 26, 2012

(30) Foreign Application Priority Data
Apr. 20, 2010 (EP) 10305407.8

(51) Int. Cl. B08B 3/02

(52) U.S. Cl. 134/34

(57) ABSTRACT

The invention relates to a method for cleaning an outer surface (1) arranged at the bottom of a tank (3), a vessel or similar, said method comprising the steps of: generating and supplying a pressurized cleaning fluid by means of a production source (2) of pressurized cleaning fluid, the fluid pressure being between 3 and 12 bar; conveying the cleaning fluid opposite the said outer surface (1) of the tank (3) by circulating the fluid in a pipe network (4) arranged below the tank (3); cleaning the outer surface (1) of the tank (3) by means of a plurality of rotating jets of cleaning fluid, the said plurality of jets being generated by at least one multi-jet rotating head (10) connected to the pipe network (4), wherein conveying of the cleaning fluid is realized by the pipe network (4) forming a closed loop (5) arranged below and near the centre (6) of the outer surface (1) of the tank (3), the said closed loop (5) being supplied with cleaning fluid by a feed pipe (7) connected to the said production source (2) of pressurized cleaning fluid.

### TECHNICAL FIELD

The invention relates to the field of cleaning relatively inaccessible surfaces generally arranged facing or opposite the ground.

The invention relates more particularly to a method and a use of multi-jet rotating heads for cleaning this type of surface, which may be formed by the outer underside of a tank, a vessel or similar.

### PRIOR ART

In general, such surfaces, due to their limited access, are difficult to clean and generally require the use of high pressure cleaning devices for spraying a cleaning fluid at a pressure of about 80 bar. An operator moves below the surface with the high pressure cleaning device, and, if necessary, can use a motor driven vehicle in order to cover the entire surface to be cleaned.

Another conventional solution is to employ nozzles attached to mobile carriages on rails. This case has the drawback of the possibility of dirt settling on the rails, and also potential derailments. Furthermore, it is necessary to employ reels for the fluid hoses (washing liquid, electricity). This creates points that are difficult to clean in the installation, and increases the price.

In fact, such surfaces may extend over several tens of square metres with large-sized vessels or tanks Such tanks may in particular allow the germination of plants or seeds, or even the fermentation of the seeds in a liquid.

However, this type of cleaning method does not guarantee the complete cleaning of the surface. This is because an operator performing the cleaning may fail to see, and therefore clean, an area that is relatively inaccessible.

Moreover, this type of device for high-pressure cleaning requires an electric power source in order to supply an electric compressor arranged inside the device.

In consequence, such a type of device may be dangerous to its user, who is therefore completely immersed in a humid atmosphere and is constantly spattered with mud. This type of device thus incurs high risks of electrocution for its user. Another drawback is that the hoses drag on the ground for the operator incurring a risk of falling.

It is therefore the purpose of the invention to supply a safe and effective solution for cleaning relatively inaccessible surfaces, located under vessels or tanks

### SUMMARY OF THE INVENTION

The invention therefore relates to a method for cleaning an outer surface arranged at the bottom of a tank, a vessel or similar, characterized in that it comprises the steps of:
generating and supplying a pressurized cleaning fluid by means of a production source of pressurized cleaning fluid, the fluid pressure being between 3 and 12 bar;
conveying the cleaning fluid opposite the said outer surface of the tank by circulating the fluid in a pipe network arranged below the tank;
cleaning the outer surface of the tank by means of a plurality of rotating jets of cleaning fluid, the said plurality of jets being generated by at least one multi-jet rotating head connected to the pipe network.

The step of conveying of the cleaning fluid is realized by the pipe network forming a closed loop arranged below and near the centre of the outer surface of the tank, the said closed loop being supplied with cleaning fluid by a feed pipe connected to the said production source of pressurized cleaning fluid.

In other words, such a cleaning method serves for the automatic cleaning of the outer surface of the tank arranged facing the ground. Such a cleaning can be carried out periodically and thus guarantees an optimal state of cleanliness of this surface. Advantageously, the rebound of the jets on the cleaned surfaces is exploited to increase the impact area and hence the quality of the cleaning.

Furthermore, the number of multi-jet rotating heads depends on the size of the surface to be cleaned, and on the shape and size of the pipe network arranged below the tank

The rotary movement of the jets is also automatic thanks to the pressure of the cleaning fluid, and requires no electric power supply nor a motor drive. The pressurized cleaning fluid drives the rotation of the jet head. Such jet heads provide a 360° indexed impact cleaning over a defined time period and the flow of cleaning fluid makes the nozzles perform a geared rotation around the vertical and horizontal axes, like, for example the heads branded under the reference MULTIJET 40 by the Applicant.

The production source of pressurized cleaning fluids may be arranged near the vessel and be incorporated in a central production unit in order to generate pressurized cleaning fluid to supply several pipe networks. In this way, the same production unit of pressurized cleaning fluid can be used to clean several juxtaposed tanks.

Moreover, the pipe network connects the closed loop, arranged below and near the centre of the surface to be cleaned, and the production source of pressurized cleaning fluid.

Such a closed loop may be formed of several straight pipe sections, and thereby have the shape of a polygon. Other shapes may be considered, such as circular or elliptical shapes in particular.

In practice, the pipe network may comprise a plurality of pipes emerging radially from the closed loop.

The number and length of these pipes accordingly depends on the size of the area to be cleaned.

According to a particular embodiment, each pipe may be straight and comprise a free end arranged near the periphery of the outer surface. In consequence, the pipe network substantially has a star shape centred with regard to the centre of the surface to be cleaned.

Such outer surfaces to be cleaned are generally circular, and in consequence, the straight pipes have the same length.

Advantageously, the pipe network and the multi-jet rotating head may each be made from a stainless steel. In consequence, a cleaning installation using this method requires no additional manual maintenance that would be performed by an operator and has very good corrosion resistance.

In practice, the pressure of the cleaning fluid may be between 8 bar to 10 bar. In fact, such a pressure combined with a flow rate of about 50 m³/h serves to optimally clean the underside of the tank. The inventive method consumes a quantity of water similar to that used by a cleaning trolley.

According to a particular embodiment, the cleaning fluid may be water. In consequence, it is possible to clean the underside of tanks which demand cleaning without detergent. Such a cleaning fluid is indispensible in particular for applications in which seeds are fermented or germinated in a solution.

Furthermore, and as already stated, the invention also relates to a use of a multi-jet rotating head, in a cleaning method as previously described, in the field of the cleaning of a tank, a vessel or similar.

### BRIEF DESCRIPTION OF THE FIGURES

The manner for implementing the invention and the advantages thereof will clearly appear from the embodiment that follows, provided for information but non-limiting, in conjunction with the appended figures, in which:

FIG. 1 is a bottom view of an installation for carrying out the cleaning method according to the invention.

FIG. 2 is a side view of the same installation for carrying out the cleaning method according to the invention.

### MANNER OF IMPLEMENTING THE INVENTION

As already stated, the invention relates to a method for cleaning an outer surface arranged at the bottom of a tank.

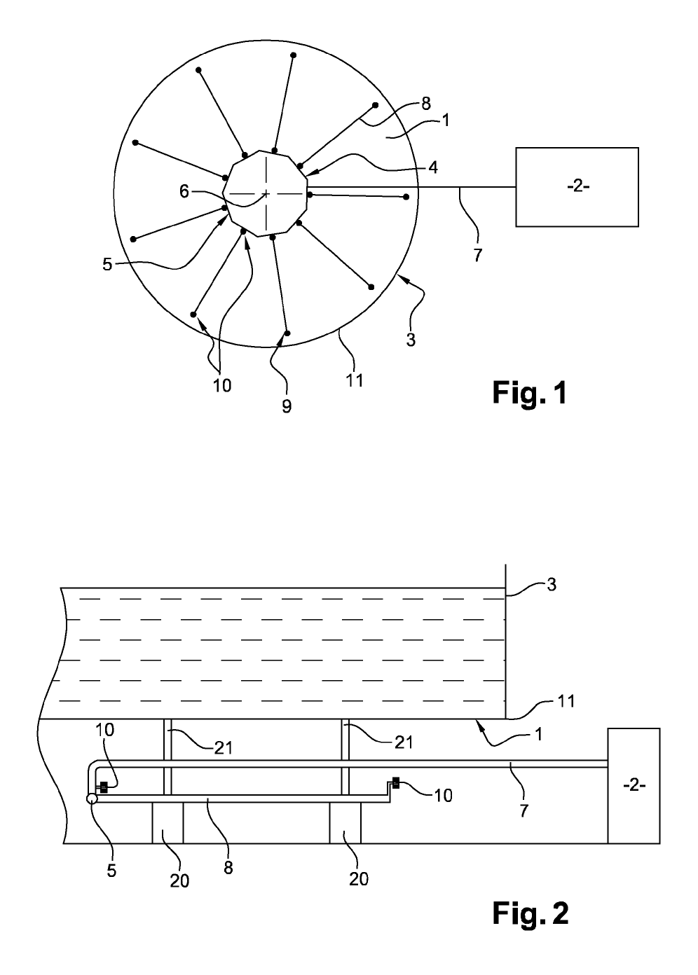

As shown in FIG. 1, the cleaning method according to the invention serves to clean an outer surface 1 of the underside of a tank 3. To carry out this method, a production source 2 is used to generate and supply a pressurized cleaning fluid.

The cleaning fluid is then conveyed below the outer surface 1 to be cleaned. Thus, a pipe network 4 comprises a closed loop 5 arranged near the centre 6 of the surface to be cleaned, and a feed pipe 7 connecting the production source to the closed loop 5.

Furthermore, straight pipes 8 emerge substantially radially from the closed loop 5. Multi-jet rotating heads 10 are connected to the pipe network 4, for cleaning the entire underside of the tank 3.

The rotating heads 10 are arranged at the two ends of the straight pipes 8, at a free end 9, and at an end connected to the closed loop 5.

Obviously, this number of rotating heads 10 may be adjusted according to the size and shape of the outer surface 1 to be cleaned. In general, a rotating head 10 serves to clean an area of about 250 m² Nevertheless such an area is theoretical considering the effective range of the jets without blind zones, associated with the columns and other cross members. For example, the total area to be cleaned could be equal to 908 m²with a tank diameter of 34 m.

As shown in FIG. 2, the tank 3 does not rest directly on the ground, and is maintained in position at a predefined height by means of columns 21, and supports 20 resting on the ground.

The pipes 8 may consequently also rest on the supports 20 and therefore do not require additional support means. As shown, the axes of rotation of the rotating heads 10 are arranged horizontally in order to clean the outer surface 1 of the tank 3.

It appears from the above that a method and a use of rotating heads according to the invention have many advantages, and in particular:
they serve to carry out an automatic cleaning of the underside of a tank;
they guarantee optimal cleaning of the surface once the cleaning is completed;
they require no maintenance and have a long service life;
they can be used for periodic cleaning of the surface at low cost.

1-7. (canceled)

8. A method for cleaning an outer surface arranged at the bottom of a tank, a vessel or a similar enclosure, comprising:
generating and supplying a pressurized cleaning fluid from a production source of pressurized cleaning fluid, the fluid pressure being between 3 and 12 bar;
conveying the cleaning fluid opposite the outer surface of the tank by circulating the fluid in a pipe network arranged below the tank;
cleaning the outer surface of the tank using a plurality of rotating jets of cleaning fluid, the plurality of jets being generated by at least one multi jet rotating head connected to the pipe network;
wherein the conveying of the cleaning fluid is realized by the pipe network forming a closed loop arranged below and near the center of the outer surface of the tank, the closed loop being supplied with cleaning fluid by a feed pipe connected to the production source of pressurized cleaning fluid.

9. The method according to claim 8, wherein the pipe network comprises a plurality of pipes emerging radially from the closed loop.

10. The method according to claim 9, wherein each pipe is straight and comprises a free end arranged near a periphery of the outer surface.

11. The method according to claim 8, wherein the pipe network and the at least one multi jet rotating head are each made from a stainless steel.

12. The method according to claim 8, wherein the pressure of the cleaning fluid is between 8 and 10 bar.

13. The method according to claim 8, wherein the cleaning fluid is water.
